(19) United States
(12) Patent Application Publication
(10) Pub. No.: US 2010/0222127 A1
(43) Pub. Date: Sep. 2, 2010

(54) GAMING SYSTEM AND A METHOD OF GAMING

(76) Inventor: Patrick Finch, Las Vegas, NV (US)

Correspondence Address: MCANDREWS HELD & MALLOY, LTD, 500 WEST MADISON STREET, SUITE 3400, CHICAGO, IL, 60661, US

(21) Appl. No.: 12/711,947

(22) Filed: Feb. 24, 2010

Related U.S. Application Data
(60) Provisional application No. 61/154,810, filed on Feb. 24, 2009.

(51) Int. Cl. A63F 9/24; A63F 13/00

(52) U.S. Cl. 463/20; 463/30; 463/25; 463/43

(57) ABSTRACT

The present disclosure provides a gaming system which comprises a symbol selector for selecting a plurality of symbols for display at display positions of a display area. The gaming system further comprises a display position selector for selecting at least one display position of the display area. The gaming system also comprises an award controller for controlling an award for a winning combination of displayed symbols. The award controller is arranged such that an award that is allocated is different if the at least one display position that is selected is included in the positions at which the winning combination of symbols is displayed.

### RELATED APPLICATIONS

This application claims priority to U.S. Provisional Application No. 61/154,810, having a filing date of Feb. 24, 2009, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a gaming system and to a method of gaming.

Video gaming machines, such as poker or slot machines, are widely used in many countries. Such gaming machines typically have a video display that simulates a number of spinning reels. Each reel has a number of symbols and a selection of the symbols is displayed on the display when the simulated reels cease spinning.

The symbols typically are displayed in an array of display positions on the video display. If the displayed symbols correspond to a predefined wining combination of symbols, the player wins a prize. Typically, the winning combination includes two or more of the symbols displayed along a “win line”, which is a predefined line through display positions which are typically adjacent.

In addition, some gaming machines offer the chance to win a Jackpot prize, which typically is a relatively large prize.

### BRIEF SUMMARY OF THE INVENTION

The present invention provides in a first aspect a gaming system comprising:

a symbol selector for selecting a plurality of symbols for display at display positions of a display area;

a display position selector for selecting at least one display position of the display area; and

an award controller for controlling an award for a winning combination of displayed symbols, the award controller being arranged such that an award that is allocated is different if the at least one display position that is selected is included in the positions at which the winning combination of symbols is displayed.

The award controller may cause an increase of an award ordinary associated with a winning combination when the at least one selected display position is included in display positions at which the winning combination is displayed. For example, the award controller may cause a multiplication of an award ordinary associated with a winning combination when the at least one selected display position is included in display positions at which the winning combination is displayed.

The award controller may be arranged such that the increase of an award ordinary associated with a winning combination is dependent on a purchase by the player or an event of the base game.

In one embodiment the award controller is arranged to control the award prior to display of the selected symbols.

The gaming system may be arranged to mark the at least one selected display position. For example, a selection symbol may be displayed at the at least one selected display position. The selection symbol may be associated with the increase of the award.

In one embodiment the gaming system is arranged so that a wild symbol is allocated at the at least one selected display position.

The gaming system may be arranged for playing at least one feature game, which may be an award of a base game. In one embodiment the feature game is triggered by an event, such as a win, of the base game.

The display position selector may be arranged to select one display position per feature game.

In one embodiment the gaming system is arranged for playing a plurality of feature game, which are associated with an award of a base game. The display position selector may be arranged to select a respective display position for each feature game. For example, the display position selector may be arranged so that a sequence of respective display positions is selected for a sequence of feature games.

The award controller may be arranged to control the award such that, if for a sequence of feature games display positions of sequence of display positions are selected, the award increases or decreases in sequence with the selected display positions. For example, the award controller may be arranged to multiply an award ordinarily associated with a winning combination of symbols with predefined multiplyer that may be dependent on a number of a column of a selected display position of the display area, such as a display area comprising 5 columns. In one specific example the increase is proportional to a column number.

The gaming system may comprise the display area for displaying symbols and having a plurality of display positions, such an array of display positions.

The gaming system may also comprise an award allocator for allocating the award when the winning combination of the symbols is displayed.

In one specific embodiment an event of a base game triggers an award of a plurality of feature games. In this embodiment the display position selector is arranged such that, when the plurality of feature games is awarded, in each feature game one display position is selected. For example, the display area may comprise 3 rows and 5 columns of display positions and 15 feature games may be awarded. The display position selector may then be arranged so that a different display position is selected in each feature game. For example, the display positions may be selected so that each selected display position is adjacent a display position that was selected in a previous feature game or will be selected in a subsequent feature game. In one specific example the display position selector is arranged to select one display position for each feature game and the award controller is arranged to control the award such that the award depends on a column number of the selected display position.

The present invention provides in a second aspect a method of gaming comprising the steps of:
selecting a plurality of symbols for display at display positions of a display area;
selecting at least one display position of the display area;
displaying selected symbols; and
controlling an award for a winning combination of displayed symbols such that an award that is allocated is
different if the at least one display position that is selected is included in the positions at which the winning combination of symbols is displayed.

The step of controlling the award may comprise increasing an award ordinary associated with a winning combination when the at least one display position is included in display positions at which the winning combination is displayed. For example, the step of controlling the award may comprise multiplying an award ordinary associated with a winning combination when the at least one selected display position is included in display positions at which the winning combination is displayed.

The step of controlling the award may be conducted such that the increase of an award ordinary associated with a winning combination is dependent on a purchase by the player or an event of the base game.

The step of selecting at least one display position may comprise marking the at least one selected display position. For example, a selection symbol may be displayed at the at least one selected display position. The selection symbol may be associated with the increase of the award.

In one embodiment the method comprises allocating and displaying a wild symbol at the at least one selected display position.

The method may comprise playing at least one feature game, the award of which being triggered by an event of a base game. The method may comprise selecting one display position per feature game.

The step of controlling the award may be conducted such that, if for a sequence of feature games display positions of a sequence of display positions are selected, the award increases or decreases in sequence with the display positions. For example, an award ordinarily associated with a winning combination of symbols may be multiplied with a predefined multiplyer that may be dependent on a number of a column of a selected display position of the display area, such as a display area comprising 5 columns. In one specific example the increase is proportional to a column number.

In one specific embodiment an event of a base game triggers an award of a plurality of feature games. In this embodiment the step of selecting at least one display position is conducted such that, when the plurality of feature games is awarded, in each feature game one display position is selected. For example, a display area may comprise 3 rows and 5 columns of display positions and 15 feature games may be awarded. The step of selecting at least one display position may then comprise selecting a different display position for each feature game. For example, the display positions may be selected so that each selected display position is adjacent a display position that was selected in a previous feature game or will be selected in a subsequent feature game. In one specific example the step of selecting at least one display position comprises selecting one display position for each feature game and the step of controlling the award is conducted such that the award depends on a column number of the selected display position.

The method may also comprise awarding an award when the winning combination of the symbols is displayed.

The present invention provides in a third aspect a computer program for instructing a computer and arranged so that, when loaded in the computer, the computer operates as a gaming system in accordance with the first aspect of the present invention.

The present invention provides in a fourth aspect a computer readable medium having a computer readable program code embodied therein for causing a computer medium to operate as a gaming system in accordance with the first aspect of the present invention.

The present invention provides in a fifth aspect a computer that is arranged for operation in accordance with the gaming system as defined by the first aspect of the present invention.

The present invention provides in a sixth aspect a data signal having a computer readable program code embodied therein and that is arranged for causing a computer to operate in accordance with the gaming system of the first aspect of the present invention.

The invention will be more fully understood from the following description of specific embodiments of the invention. The description is provided with reference to the accompanying drawings.

### BRIEF DESCRIPTION OF SEVERAL VIEWS OF THE DRAWINGS

FIG. 1 is a schematic block diagram of components of a gaming system in accordance with an embodiment of the present invention;

FIG. 2 is a schematic block diagram of functional components of a gaming system in accordance with an embodiment of the present invention;

FIG. 3 is a diagrammatic representation of a gaming system in accordance with an embodiment of the present invention with the gaming system implemented in the form of a stand alone gaming machine;

FIG. 4 is a schematic block diagram of operative components of the gaming machine shown in FIG. 3;

FIG. 5 is a schematic block diagram of components of a memory of the gaming machine shown in FIG. 3;

FIG. 6 is a schematic diagram of a gaming system in accordance with an alternative embodiment of the present invention with the gaming system implemented over a network;

FIG. 7 is a flow diagram illustrating game play of a gaming system in accordance with an embodiment of the present invention;

FIG. 8 is a diagrammatic representation of an example screen displayed by a gaming system in accordance with an embodiment of the present invention during implementation of normal game mode;

FIG. 9 is a diagrammatic representation of an example screen displayed by a gaming system in accordance with an embodiment of the present invention during implementation of special game mode;

FIG. 10 is another diagrammatic representation of the example screen shown in FIG. 9; and

FIG. 11 is a further diagrammatic representation of the example screen shown in FIG. 9.

### DETAILED DESCRIPTION OF THE INVENTION

The present gaming system operates such that during game play a plurality of symbols are randomly selected from a set of symbols and displayed at a plurality of display positions, the symbols shown at the display positions being used to determine game outcomes using defined win patterns.

In one conventional type of gaming machine, a display area including 15 display positions is presented to a player with the display positions being the same size and each display position including one symbol. The display positions are arranged in 5 vertically disposed reels with each reel having 3 visible display positions defining a 3 row×5 column display matrix having coordinates R₁C₁-R₃C₅ (Rᵢ: row number, Cᵢ: column number).

After the reels are spun and subsequently stopped, the display positions show a random selection of symbols. Generally with such games a plurality of win patterns in the form of win lines are defined which extend across the reels and include one display position from each reel. Typically, in order for two display positions in adjacent reels to form part of a win line, the display positions must be disposed adjacent each other.

In one embodiment, an event of a base game (such as a level of credits that are accumulated) triggers allocation of feature games, such as 15 feature games. In each feature game one display position is selected and if a selected display position is included in a winning combination of symbols, an award is modified (for example multiplied) in a predefined manner. In one variation a wild symbol is also provided at the selected display position.

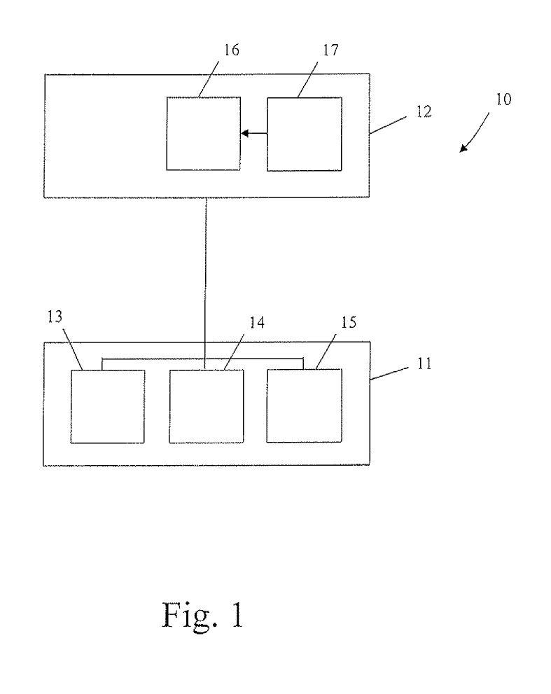

Referring now to FIG. 1, there is shown a schematic block diagram of a gaming system 10 arranged to implement a probabilistic game of the type wherein several symbols from a set of symbols are randomly displayed, and a game outcome is determined on the basis of the displayed symbols. The system may have a single mode of operation or may be of the type including multiple game modes such as operable in normal game mode wherein the base game is implemented and special game mode wherein the feature games are implemented.

With some such probabilistic games, the set of symbols used during normal game mode includes standard symbols and function symbols, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display along a win line, or are displayed according to defined outcome patterns such as scattered anywhere in the display matrix, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

FIG. 1 shows a schematic diagram of components of a gaming system 10. The components comprise a player interface 11 and a game controller 12. The player interface 11 is arranged to enable interaction between a player and the gaming system and for this purpose includes input/output components required for the player to enter instructions and play the game.

Components of the player interface 11 may vary, but will typically include a credit mechanism 13 to enable a player to input credits and receive payouts, one or more displays 14 which may comprise a touch screen, and a game play mechanism 15 arranged to enable a player to input game play instructions.

The game controller 12 is in data communication with the player interface 11 and typically includes a processor 16 arranged to process game play instructions and output game player outcomes to the display 14. Typically, the game play instructions are stored as program code in a memory 17 that can also be hardwired. It will be understood that in this specification the term “processor” is used to refer generically to any device that can process game play instructions and may include a microprocessor, microcontroller, programmable logic device or other computational device such as a personal computer or a server.

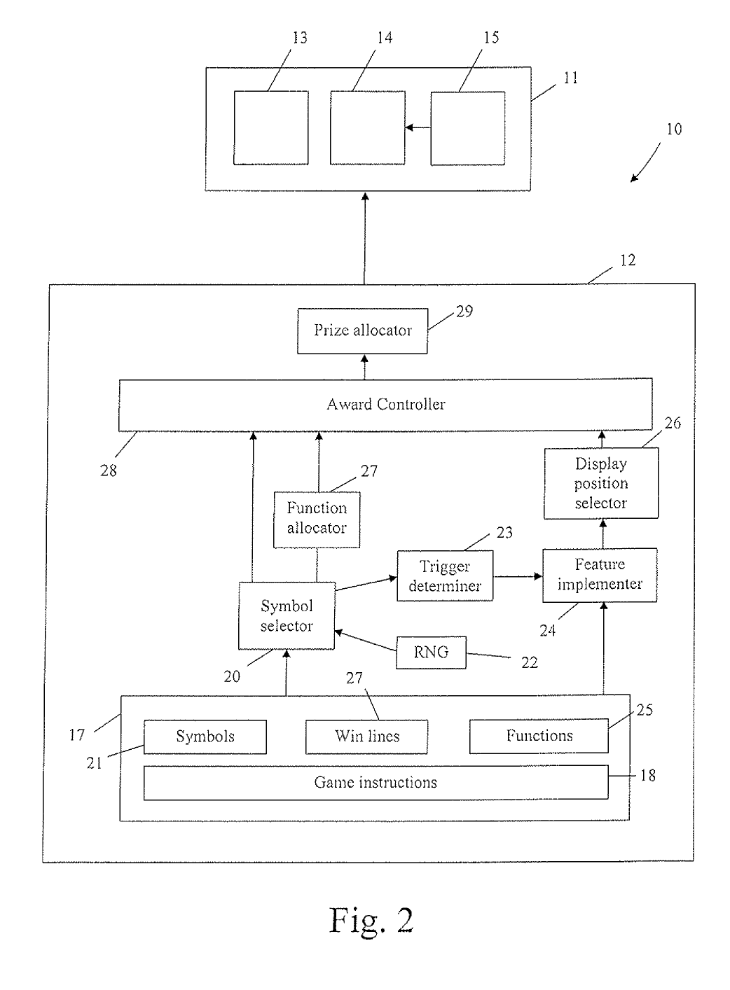

A functional diagram illustrating operative components of the game controller 12 is shown in FIG. 2.

The memory 17 is arranged to store symbols data 21 indicative of a plurality of symbols, win lines data 27 indicative of available win lines, function data 25 indicative of one or more functions allocatable to the symbols, and game instruction data 18 indicative of game instructions usable by the gaming machine 10 to control operation of the game.

The game controller 12 includes a symbol selector 20 which is arranged to select several symbols from the available symbols 21 for display to a player in a plurality of display positions, in this example by spinning reels containing the symbols and stopping the reels so as to display at least one symbol on each reel. In this example, the selection carried out by the symbol selector 20 is made using a random number generator 22.

It will be appreciated that the random number generator 22 may be of a type which is arranged to generate pseudo random numbers based on a seed number, and that in this specification the term “random” will be understood accordingly to mean truly random or pseudo random.

In this embodiment, the game controller 12 also comprises a trigger determiner 23 arranged to determine whether a trigger condition exists and to instruct a feature implementer 24 to implement a special game mode when a trigger condition has been detected. Such a trigger condition may be display of a particular symbol or combination of symbols.

The feature implementer 24 controls a display position selector 26 to select a display position.

In this example, the game controller 12 also comprises a function allocator 27 arranged to select and allocate one or more functions to one or more symbols. Such functions include a wild function, a scatter function, or any other function which may be applied to a symbol or to the game.

The game controller 12 also comprises an award controller 28 which in accordance with the game instructions 18 determines game outcomes based on the symbols selected for display to the player by the symbol selector 20. The award controller 28 allocates predefined influences on the award to display positions. When the display positions at which a winning combination of symbols is displayed include a selected display position, the award is influenced (for example multiplied) in a predefined manner as determined by the influence allocated by the award controller 28 to that display position that is selected.

The game controller 12 also comprises a prize allocator 29 arranged to allocate a prize to a player when a winning outcome exists.

In this example, the gaming system is operable in normal game mode and special game mode.

During normal game mode, such as during a base game, each reel is associated with a plurality of display positions, in this example 3 display positions, with each display position showing one symbol.

During special game mode, such as during a feature game, the gaming system is arranged such that at least one display position has an award influence allocated to it such that, when that display position is selected and included in a winning combination of displayed symbols, the award is modified (for example multiplied) in a predefined manner.

In one specific variation the gaming system 10 is arranged so that an event of a base game triggers an award of one or more feature games. The display position selector 26 is arranged so that, when a plurality of feature games is awarded, in each feature game one display position is selected. For example, the display 14 may comprise 3 rows and 5 columns of display positions and 15 feature games may be awarded. In this case the display position selector 26 is arranged so that a different display position is selected in each feature game.

In this embodiment the symbol selector 20, the trigger determiner 23, the feature implementer 24, the display position selector 26, the function allocator 27, the award controller 28, and the prize allocator 29 are at least partly implemented using the processor 16 and associated software, although it will be understood that other implementations are envisaged.

The gaming system 10 can take a number of different forms.

In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

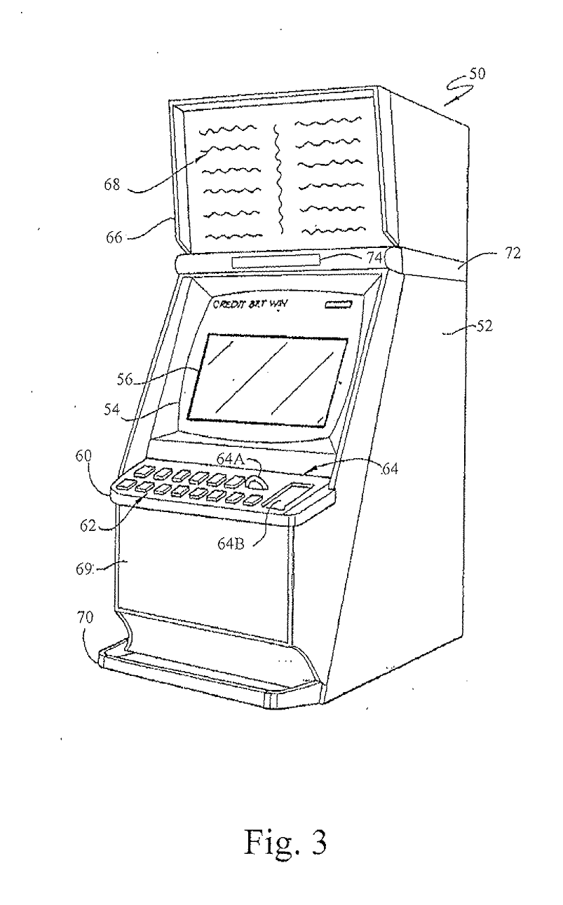

A gaming system in the form of a stand alone gaming machine 50 is illustrated in FIG. 3. The gaming machine 50 includes a console 52 having a display 54 on which is displayed representations of a game 56 that can be played by a player. A mid-trim 60 of the gaming machine 50 houses a bank of buttons 62 for enabling a player to interact with the gaming machine, in particular during game play. The mid-trim 60 also houses a credit input mechanism 64 which in this example includes a coin input chute 64A and a bill collector 64B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 66 may carry artwork 68, including for example pay tables and details of bonus awards and other information or images relating to the game. Further artwork and/or information may be provided on a front panel 69 of the console 52. A coin tray 70 is mounted beneath the front panel 69 for dispensing cash payouts from the gaming machine 50.

The display 54 is in the form of a video display unit, particularly a cathode ray tube screen device. Alternatively, the display 54 may be a liquid crystal display, plasma screen, or any other suitable video display unit. The top box 66 may also include a display, for example a video display unit, which may be of the same type as the display 54, or of a different type. The display 54 may comprise a touch screen usable by a player to interact with the gaming machine, in particular during game play.

The display 54 in this example is arranged to display representations of several reels, each reel of which has several associated symbols. Typically 3, 4 or 5 reels are provided. During operation of the game, the reels first appear to rotate then stop with symbols visible on each reel. Game outcomes are determined on the basis of the visible symbols together with any special functions associated with the symbols.

A player marketing module (PMM) 72 having a display 74 is connected to the gaming machine 50. The main purpose of the PMM 72 is to allow the player to interact with a player loyalty system. The PMM 72 has a magnetic card reader for the purpose of reading a player tracking device, for example as part of a loyalty program. However other reading devices may be employed and the player tracking device may be in the form of a card, flash drive or any other portable storage medium capable of being read by the reading device. In this example, the PMM 72 is a Sentinel III device produced by Aristocrat Technologies Pty Ltd.

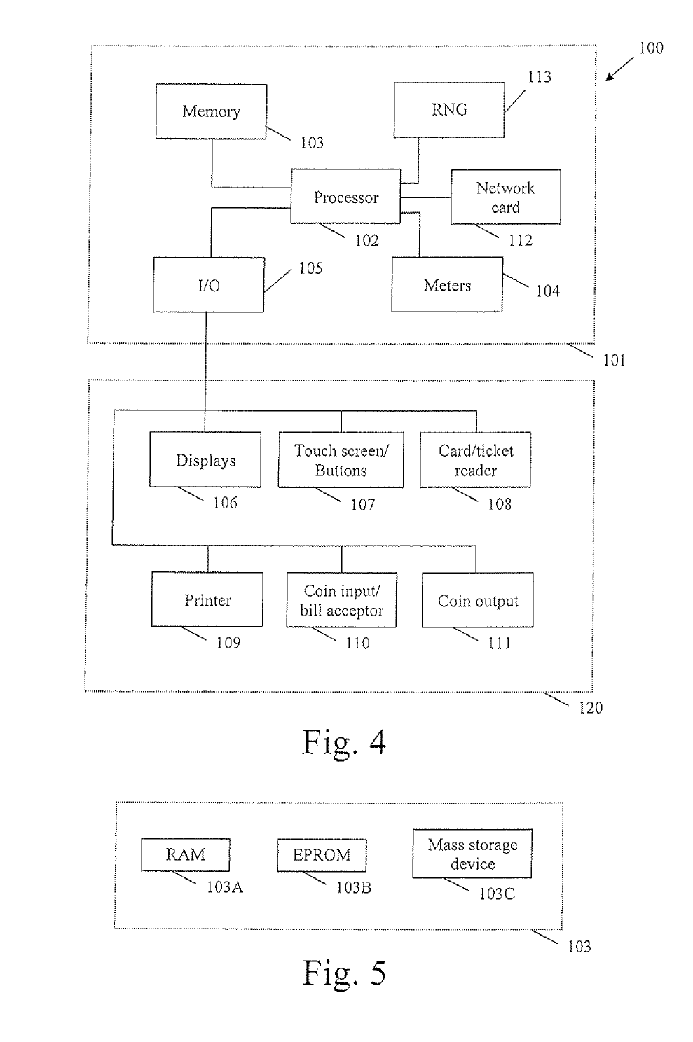

FIG. 4 shows a block diagram of operative components of a gaming machine 100 which may be the same as or different to the gaming machine shown in FIG. 3.

The gaming machine 100 includes a game controller 101 having a processor 102. Instructions and data to control operation of the processor 102 in accordance with the present invention are stored in a memory 103 which is in data communication with the processor 102.

Typically, the gaming machine 100 will include both volatile and non-volatile memory and more than one of each type of memory, with such memories being collectively represented by the memory 103.

FIG. 5 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

The gaming machine has hardware meters 104 for purposes including ensuring regulatory compliance and monitoring player credit, an input/output (I/O) interface 105 for communicating with a player interface 120 of the gaming machine 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 4, the peripheral devices that communicate with the game controller 101 comprise one or more displays 106, a touch screen and/or bank of buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

It is also possible for the operative components of the gaming machine 100 to be distributed, for example input/output devices 106,107,108,109,110,111 may be provided remotely from the game controller 101.

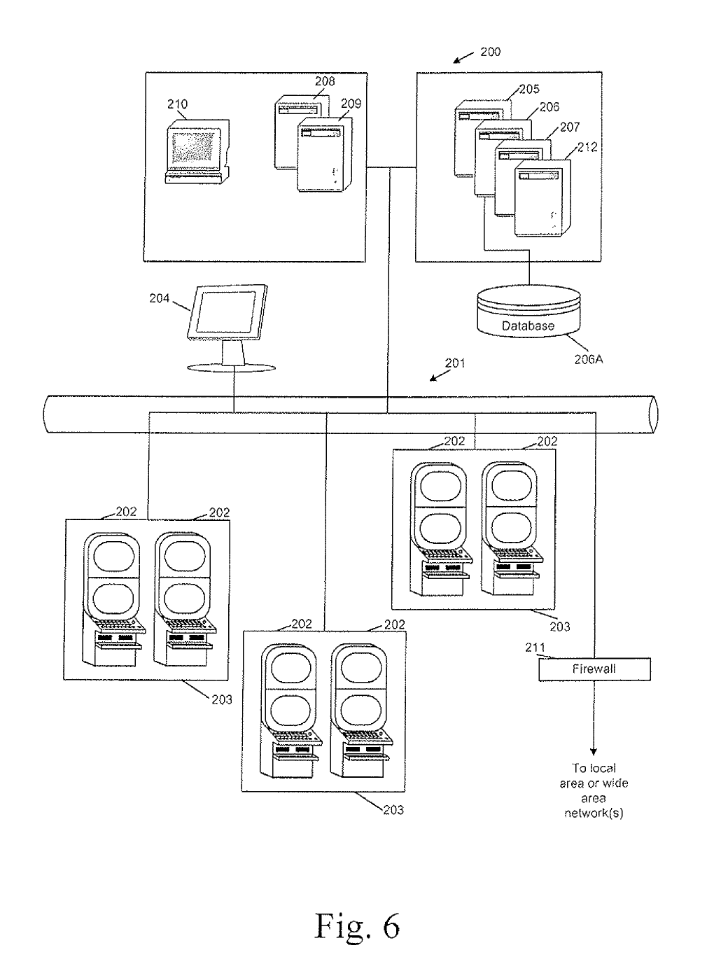

FIG. 6 shows a gaming system 200 in accordance with an alternative embodiment. The gaming system 200 includes a network 201, which for example may be an Ethernet network, a LAN or a WAN. In this example, three banks 203 of two gaming machines 202 are connected to the network 201. The gaming machines 202 provide a player operable interface and may be the same as the gaming machines 40,100 shown in FIGS. 3 and 4, or may have simplified functionality depending on the requirements for implementing game play. While banks 203 of two gaming machines are illustrated in FIG. 6, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, a game server 205 implements part of the game played by a player using a gaming machine 202 and the gaming machine 202 implements part of the game. With this embodiment, as both the game server 205 and the gaming machine 202 implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a variation of the above thick client embodiment, the gaming machine 202 may implement the game, with the game server 205 functioning merely to serve data indicative of a game to the gaming machine 202 for implementation.

With this implementation, a data signal containing a computer program usable by the client terminal to implement the gaming system may be transferred from the game server to the client terminal, for example in response to a request by the client terminal.

In a thin client embodiment, the game server 205 implements most or all of the game played by a player using a gaming machine 202 and the gaming machine 202 essentially provides only the player interface. With this embodiment, the game server 205 provides the game controller. The gaming machine will receive player instructions, and pass the instructions to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming system 200, including for example a gaming floor management server 208 and a licensing server 209 to monitor the use of licenses relating to particular games. An administrator terminal 210 is provided to allow an administrator to monitor the network 201 and the devices connected to the network.

The gaming system 200 may communicate with other gaming systems, other local networks such as a corporate network, and/or a wide area network such as the Internet, for example through a firewall 211.

A loyalty program server 212 may also be provided.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random number generator engine. Alternatively, a separate random number generator server could be provided.

Examples of specific implementations of the gaming system will now be described in relation to a stand alone gaming machine 10, 50, 100 although it will be understood that implementation may also be carried out using other gaming system architectures such as a network architecture of the type shown in FIG. 6.

In this example, the gaming system is operable in normal game mode, such as for playing a base game, and special game mode, such as for playing a feature game. The gaming system comprises four reels, each of which has an associated set of symbols.

The reels comprise standard symbols and optionally one or more function symbols and win outcomes are determined on the basis of the symbols visible at the display positions when the reels stop rotating.

Typically, a player will purchase or otherwise obtain win entitlements such as one or more win lines which are used in the game to determine win outcomes. Each win line typically includes a display position from each reel, and generally win line display positions in adjacent reels must be adjacent to each other. If the displayed symbols on the reels have symbols associated with a winning combination such as disposed on a win line, the player wins a prize.

The gaming system may be arranged to commence special game mode when a predetermined game outcome occurs, and special game mode may comprise one or more free games. Special game mode may commence automatically on the basis of a game event occurring during a game such as display of a particular symbol, based on game outcomes determined by the gaming system, or may be prompted by a player pressing a button on the gaming system 50 after the player has identified that a game outcome corresponding to special game mode requirements has occurred.

The gaming system 10, 50, 100 may also be arranged so as to determine eligibility for special game mode, for example based on the amount or type of bet placed, based on certain time periods and so on.

Special game mode may also be arranged to commence when a special game is purchased by a player.

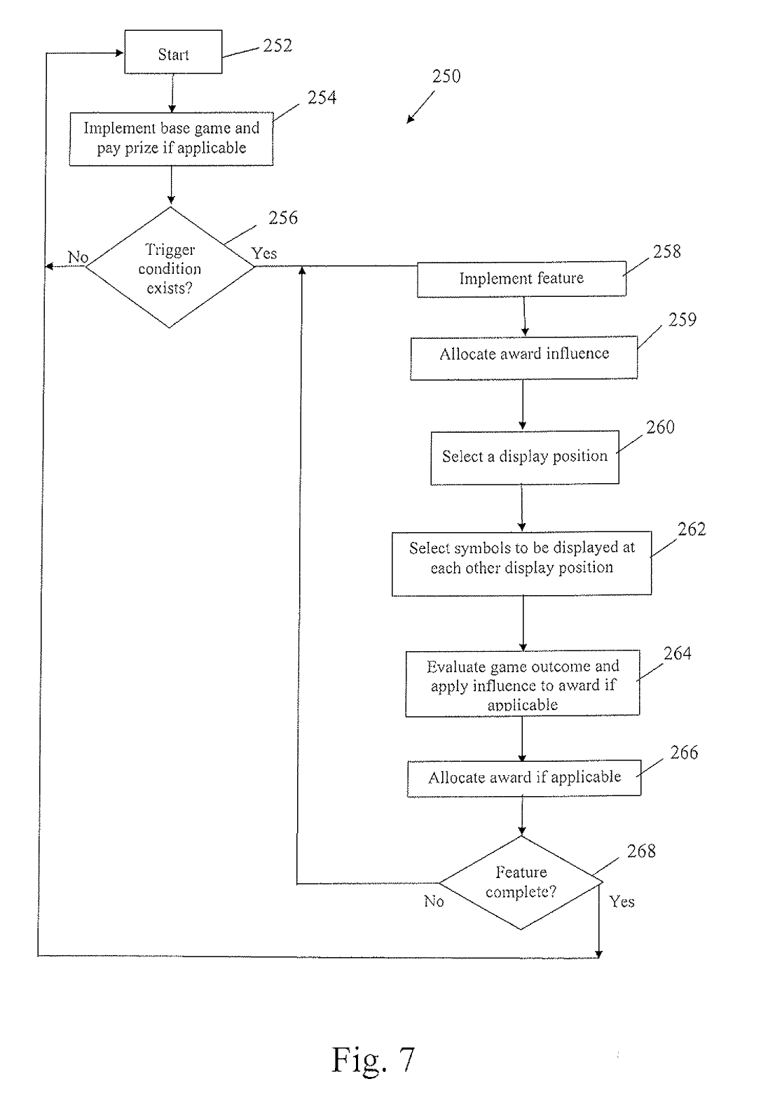

A specific example will now be described in relation to flow diagram 250 as shown in FIG. 7 which illustrates steps 252 to 268 of a method of gaming implemented by the gaming system according to the present embodiment.

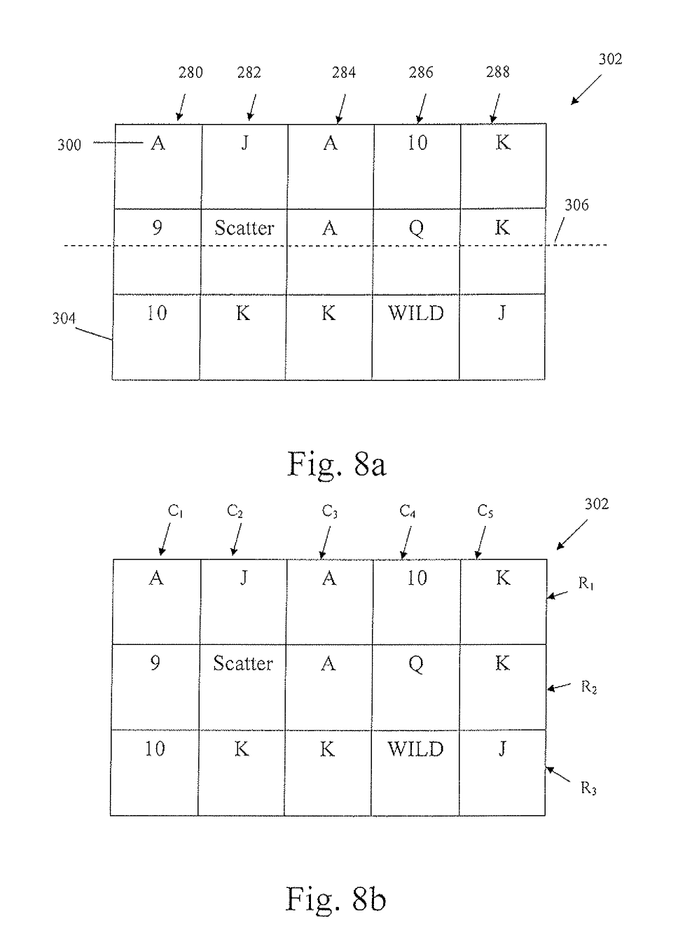

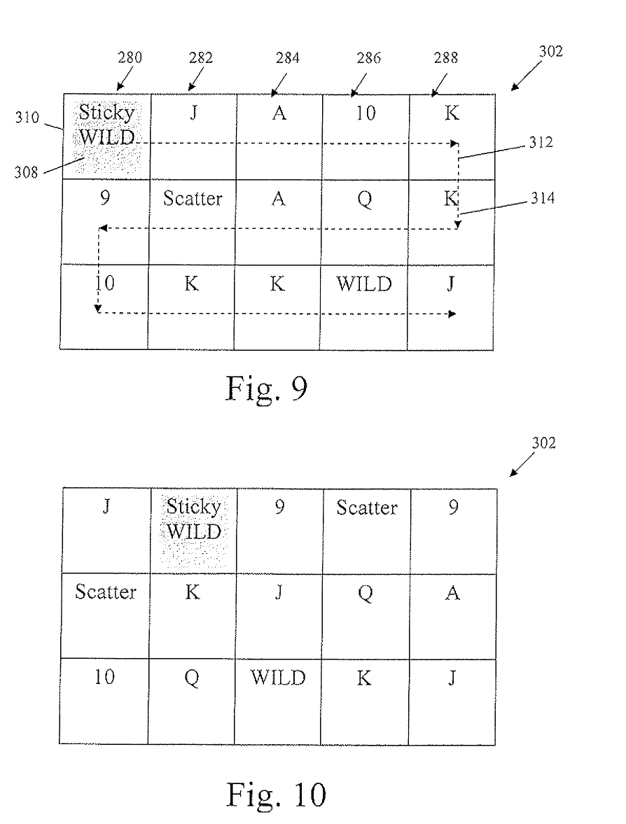

In this example, five virtual reels 280, 282, 284, 286 and 288 are provided and displayed on a graphical display device 54 in a display area 302 as shown in FIGS. 8 and 9. However, it will be understood that any number of reels may be provided.

During implementation of a base game, the reels are spun and subsequently stopped to show a plurality of symbols 300 in the display area 302. The display area 302 is divided into 15 display positions 304, with each display position showing one symbol 300 and each reel including three associated display positions 304. The display matrix in this example defines a 3 row×5 column display matrix having coordinates R₁C₁ to R₃C₅.

Winning outcomes are determined with reference to symbols appearing in predefined win lines 306 or predefined win combinations such as predefined scatter combinations. Each predefined win line 306 includes one display position from each reel. It is to be appreciated that the win line 306 is only one example of many possible win lines, which may horizontal, angled an/or may not be straight.

The game includes the initial step 252 of starting the game. Sep 254 determines whether the symbols displayed at the display positions correspond to a winning outcome. If a winning outcome exists on an enabled win line, an award associated with the winning outcome is awarded to the player.

Step 256 controls if a trigger condition exists. If this is the case, a special game mode commences which causes implementation of one or more special feature (step 258). In this example the special feature includes 15 feature games. These feature games, in this example, are free in that the player need not make an additional wager.

Award influences are allocated to display positions (step 259). For example, multipliers 1×, 2×, 3×, 4× and 5× may be allocated to the display positions of reels 280, 282, 284, 286 and 288, respectively.

One display position is selected per feature game (step 260). In this example the display position that is selected is marked on the display by a marking 308, which may be provided in any suitable form. Thus in this example for the first feature game the position at R₁C₁ is made wild for that first game.

The reels are then spun and subsequently stopped to show a plurality of symbols in the display positions. Winning outcomes are then determined with reference to symbols appearing in predefined win lines including the award modifier (i.e. the wild symbol at position R₁C₁) which itself may take the form of a symbol such as a wild symbol 310.

In one embodiment, the display positions that are selected in a sequence of feature games may form a sequence of display position of the display area 302. For example, a selected display position of a first feature game may be positioned at the top of 280 (e.g. R1C1) and sequentially progress horizontally for the next feature game to R₁C₂, for the third feature game to R1C3 and so forth through the sequence of the feature games ending at position R₂C₅ for the 15th feature game may be located in reel 288 at the bottom and the selected display positions may move from one feature game to another in a “a “zigzag” pattern 312 as suggested by the dotted line in FIG. 9.

In each feature game symbols are then selected for display (step 262), the outcome is evaluated (step 264) and an award allocated if applicable (step 266). If the sequence of features is not complete, a further feature game commences.

A wild symbol is allocated to each selected display position as indicated in FIG. 9 for the first feature game. When a feature game is played the reels are spun as normal, however a symbol that would normally appear in the location of the selected display position is replaced by the wild symbol 310. As the wild symbol 310 remains in that display position for the duration of the first feature game, it is referred to as a ‘sticky’ wild symbol.

Although this example describes the positions of selected display positions moving from one feature game to another in a in zigzag pattern 312 through each of a sequence of feature games, it will be appreciated that the locations of the selected display positions may alternatively move in any fashion from one feature game to another, for example randomly, or in another predefined pattern.

As described above, the award is modified in a predefined way if a selected display position is included in a winning combination of displayed symbols. The award can be modified by multiplying the award by any predefined factor or by adding any predefined amount to the award or by any other suitable modification (also including multiplication by a factor of 1 and addition of 0).

In the arrangement shown in FIG. 10, an award influence is associated with a factor 2 is allocated to display positions of reel 282. Consequently, if one of the display positions of reel 282 is selected and included in a winning combination of displayed symbols, the award ordinary associated with the winning combination is multiplied by the factor of 2. In this example the selection of one display position is associated with the provision of the wild symbol 310 (2nd feature game).

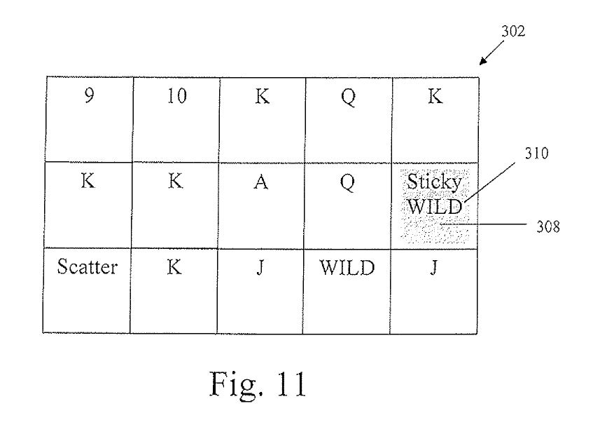

In the arrangement shown in FIG. 11, an award influence is associated with a factor 5 is allocated to display positions of reel 288. Consequently, if one of the display positions of reel 288 is selected and included in a winning combination of displayed symbols, the award ordinary associated with the winning combination is multiplied by the factor of 5. In this example the selection of one display position is associated with the provision of the wild symbol 310 (10th feature game). For example, an award of a the feature game may be associated with a multiplier corresponding to the reel number, as numbered from left to right. For example, if the wild symbol is in position R₁C₅ any award incorporating the wild symbol would be multiplied by 5. When the feature game positions the wild symbol in position R₂C₃ the multiplier would be 3.

It will be understood that with the above described embodiments awards are modified according to multiplying factors that are dependent on the display positions. However, variations are possible. Fore example, the award influences that are allocated may be displayed, typically on the respective display positions. Further, the awards may be modified in any other suitable manner. An award influences for a subsequent feature game may also be allocated after completion of a feature game and the award influence associated with the subsequent feature game may be dependent on the outcome of a completed feature game. The wild symbols may not necessarily be allocated to selected display positions. Selected display positions may be marked in any other way or may not be marked.

1. A gaming system comprising:
a symbol selector for selecting a plurality of symbols for display at display positions of a display area;
a display position selector for selecting at least one display position of the display area; and
an award controller for controlling an award for a winning combination of displayed symbols, the award controller being arranged such that an award that is allocated is different if the at least one display position that is selected is included in the positions at which the winning combination of symbols is displayed.

2. The gaming system of claim 1 wherein the award controller is arranged to cause an increase of an award ordinary associated with a winning combination when the at least one selected display position is included in display positions at which the winning combination is displayed.

3. The gaming system of claim 1 wherein the award controller is arranged to cause a multiplication of an award ordinary associated with a winning combination when the at least one selected display position is included in display positions at which the winning combination is displayed.

4. The gaming system of claim 2 wherein the award controller is arranged such that the increase of an award ordinary associated with a winning combination is dependent on a purchase by the player or an event of the base game.

5. The gaming system of claim 1 wherein the award controller is arranged to control the award prior to display of selected symbols.

6. The gaming system of claim 1 wherein the gaming system is arranged to mark the at least one selected display position.

7. The gaming system of claim 6 wherein the gaming system is arranged such that a selection symbol is displayed at the at least one selected display position.

8. The gaming system of claim 1 wherein the gaming system is arranged so that a wild symbol is allocated at the at least one selected display position.

9. The gaming system of claim 1 wherein the gaming system is arranged for playing at least one feature game.

10. The gaming system of claim 9 wherein the feature game is triggered by an event of the base game.

11. The gaming system of claim 9 wherein the feature game is an award of a base game.

12. The gaming system of claim 9 wherein the display position selector is arranged to select one display position per feature game.

13. The gaming system of claim 1 wherein the gaming system is arranged for playing a plurality of feature game, which are associated with an award of a base game and wherein the display position selector is arranged to select a respective display position for each feature game.

14. The gaming system of claim 12 wherein the display position selector is arranged so that a sequence of respective display positions is selected for a sequence of feature games.

15. The gaming system of claim 9 wherein the award controller is arranged to control the award such that, if for a sequence of feature games display positions of a sequence of display positions are selected, the award increases or decreases in sequence with the selected display positions.

16. The gaming system of claim 15 wherein the award controller is arranged to multiply an award ordinarily associated with a winning combination of symbols with predefined multiplyer that dependents on a number of a column of a selected display position of the display area.

17. The gaming system of claim 1 comprising the display area for displaying symbols and having a plurality of display positions.

18. The gaming system of claim 1 wherein the gaming system is arranged so that an event of a base game triggers an award of a plurality of feature games and wherein the display position selector is arranged such that, when the plurality of feature games is awarded, in each feature game one display position is selected and wherein the display position selector is arranged so that each selected display position is adjacent a display position that was selected in a previous feature game or will be selected in a subsequent feature game.

19. A method of gaming comprising the steps of:
selecting a plurality of symbols for display at display positions of a display area;
selecting at least one display position of the display area;
displaying selected symbols; and
controlling an award for a winning combination of displayed symbols such that an award that is allocated is different if the at least one display position that is selected is included in the positions at which the winning combination of symbols is displayed.

20. The method of claim 19 wherein the step of controlling the award comprises increasing an award ordinary associated with a winning combination when the at least one display position is included in display positions at which the winning combination is displayed.

21. The method of claim 19 wherein the step of controlling the award comprises multiplying an award ordinary associated with a winning combination when the at least one selected display position is included in display positions at which the winning combination is displayed.

22. The method of claim 20 wherein the step of controlling the award is conducted such that the increase of an award ordinary associated with a winning combination is dependent on a purchase by the player.

23. The method of claim 19 wherein the step of selecting at least one display position comprises marking the at least one selected display position.

24. The method of claim 23 wherein a selection symbol is displayed at the at least one selected display position.

25. The method of claim 19 comprising allocating and displaying a wild symbol at the at least one selected display position.

26. The method of claim 19 comprising playing at least one feature game.

27. The method of claim 26 wherein the at least one feature game is triggered by an event of a base game.

28. The method of claim 26 comprising selecting one display position per feature game.

29. The method of claim 26 wherein the step of controlling the award is conducted such that, if for a sequence of feature games display positions of a sequence of display positions are selected, the award increases or decreases in sequence with the display positions.

30. The method of claim 29 wherein an award ordinarily associated with a winning combination of symbols is multiplied with a predefined multiplyer that dependents on a number of a column of a selected display position of the display area.

31. The method of claim 19 wherein
an event of a base game triggers an award of a plurality of feature games; and wherein the step of selecting at least one display position is conducted such that, when the plurality of feature games is awarded, in each feature game one display position is selected; and wherein the step of selecting at least one display position is conducted so that each selected display position is adjacent a display position that was selected in a previous feature game or will be selected in a subsequent feature game.

32. The method of claim 31 wherein the display positions are selected so that each selected display position is adjacent a display position that was selected in a previous feature game or will be selected in a subsequent feature game.

33. The gaming system of claim 1, further comprising a computer program for instructing a computer and arranged so that, when loaded in the computer, the computer operates as the gaming system.

34. The gaming system of claim 1, further comprising a computer readable medium having a computer readable program code embodied therein for causing a computer medium to operate the gaming system.

35. The gaming system of claim 1, further comprising a computer that is arranged for operation in accordance with the gaming system.

36. The gaming system of claim 1, further comprising a data signal having a computer readable program code embodied therein and that is arranged for causing a computer to operate in accordance with the gaming system.
